(19) United States
(12) Patent Application Publication
(10) Pub. No.: US 2022/0199993 A1
(43) Pub. Date: Jun. 23, 2022

(54) ELECTRODE FORMULATION FOR LI-ION BATTERY AND METHOD FOR PRODUCING AN ELECTRODE BY EXTRUSION AT LOW RESIDENCE TIME

(71) Applicant: ARKEMA FRANCE, Colombes (FR)

(72) Inventors: Oleksandr Korzhenko, Lacq (FR); Christophe Vincendeau, Lacq (FR)

(21) Appl. No.: 17/599,599

(22) PCT Filed: Mar. 12, 2020
(86) PCT No.: PCT/FR2020/050518

§ 371 Date: Sep. 29, 2021

(30) Foreign Application Priority Data
Mar. 29, 2019 (FR) 1903315

(51) Int. Cl. H01M 4/525; H01M 10/0525; H01M 4/505; H01M 4/62; H01M 4/131; H01M 4/04

(52) U.S. Cl. CPC H01M 4/525; H01M 10/0525; H01M 4/505; H01M 4/0435; H01M 4/625; H01M 4/131; H01M 4/623

(57) ABSTRACT

The invention relates to an electrode formulation for a Li-ion battery. The invention also relates to a method for preparing electrodes using said formulation by compounding/extrusion at low residence time. The invention further relates to an electrode obtained by this method and to secondary Li-ion batteries comprising at least one such electrode.

### FIELD OF THE INVENTION

The present invention relates generally to the field of electrical energy storage in rechargeable storage batteries of Li-ion type. More specifically, the invention relates to an electrode formulation for a Li-ion battery. The invention also relates to a process for the preparation of electrodes employing said formulation, by compounding/extrusion comprising a low residence time. The invention relates finally to an electrode obtained by this process and also to Li-ion storage batteries comprising at least one such electrode.

### TECHNICAL BACKGROUND

A Li-ion battery includes at least one negative electrode or anode coupled to a copper current collector, a positive electrode or cathode coupled to an aluminum current collector, a separator and an electrolyte. The electrolyte consists of a lithium salt, generally lithium hexafluorophosphate, mixed with a solvent which is a mixture of organic carbonates, which are chosen in order to optimize the transportation and the dissociation of the ions. A high dielectric constant favors the dissociation of the ions, and thus the number of ions available in a given volume, while a low viscosity favors the ionic diffusion which plays an essential role, among other parameters, in the speeds of charge and discharge of the electrochemical system.

For their part, the electrodes generally comprise at least one current collector on which is deposited a composite material consisting of: a material said to be active because it exhibits an electrochemical activity with respect to lithium, a polymer which acts as binder, plus one or more electronically conductive additives which are generally carbon black or acetylene black, and optionally a surfactant.

During charging, lithium becomes inserted into the active material of the negative electrode and its concentration is kept constant in the solvent by the deintercalation of an equivalent amount of the active material from the positive electrode. The insertion into the negative electrode results in a reduction of the lithium and it is thus necessary to contribute, via an external circuit, electrons to this electrode, originating from the positive electrode. At discharging, the reverse reactions take place.

It is known that the fact of replacing carbon black or acetylene black by carbon nanotubes (CNTs), or else of adding CNTs to such conductive additives, exhibits numerous advantages: increase in electrical conductivity, better incorporation around the particles of active material, good intrinsic mechanical properties, ability to form an electrical network better connected in the body of the electrode and between the metal collector and the active material, good maintenance of the cycling capacity in the electrode composite material, and the like.

The introduction of CNTs into the formulations of the materials constituting the electrodes presents difficulties. Thus, when the dispersion of the CNTs is carried out directly in the liquid formulations (especially in the bases of organic solvents), there is a strong viscosification of the dispersion and a low stability of such a dispersion when the mixture does not contain polymers or stabilizing agents. Recourse is had, in order to overcome this disadvantage, to bead mixers, mills and high-shear mixers.

In order to overcome these problems, the applicant company has provided, in the document WO 2011/117530, a masterbatch in agglomerated solid form comprising from 15% to 40% by weight of CNTs, at least one solvent and from 1% to 40% by weight of at least one polymer binder. Furthermore, the document EP 2 081 244 describes a liquid dispersion based on CNTs, on a solvent and on a binder, which is intended to be sprayed onto a layer of active electrode material.

These solutions are still imperfect because they do not always make it possible to avoid the persistence of CNT aggregates in these compositions, so that a fraction of the CNTs is not used optimally to improve the electrical conductivity of the electrode obtained from these compositions.

Furthermore, the document US 2011/171364 describes a paste based on CNT agglomerates which are mixed with a dispersant, such as poly(vinylpyrrolidone) or PVP, with an aqueous or organic solvent and optionally with a binder. The process for the manufacture of this paste comprises a stage of grinding (or subjecting to ultrasound) tangled dusters of CNTs, having a mean diameter of approximately 100 μm. This stage makes it possible to obtain CNT agglomerates having a size of less than 10 μm in at least one dimension, that is to say a degree of dispersion, on the Hegman scale, of greater than 7. The grinding can be carried out before or after mixing of the CNTs with the dispersant, the solvent and the optional binder.

The solution provided in this document exhibits the disadvantage of using a manufacturing process comprising a stage of grinding, preferably by pulverization, which is liable to exhibit risks of environmental pollution, indeed even health risks. In addition, the paste obtained has a viscosity of at least 5000 cPs, which can cause dispersion difficulties in some cases.

The document US 2011/0171371 describes the preparation of a Li-Ion battery electrode, comprising a composition based on carbon nanotubes. In order to facilitate the dispersion of the carbon nanotubes in the composition having a low binder content, the size of the CNT agglomerates is reduced in particular using a jet mill.

Another solution has been provided by the applicant company in the document EP 2 780 401, which describes the use of a kneading device for preparing the composition including carbon-based conductive fillers, a solvent and a binder, and the use of a dispersant, such as PVP, in this composition. This process makes it possible to render the carbon-based conductive fillers easy to handle for applications in the liquid phase, by dispersing them efficiently in a medium containing a solvent and a binder, suitable in particular for the manufacture of an electrode, without having recourse to a stage comprising the grinding (in particular in a bead mill or by pulverization), the subjecting to ultrasound or the passing through a rotor-stator system of carbon-based conductive fillers, and without using a surfactant.

However, this process exhibits the disadvantage of requiring several stages for the preparation of a battery electrode. This is because each ingredient has to be prepared beforehand by means of mixers or planetary mixers, which implies the use of up to 24 lines of mixers for a production line of 8 GWh. In point of fact, the optimization of the processes for the manufacture of electrodes remains a priority for the manufacturers of Li-ion batteries.

There thus exists a need to provide formulations of Li-ion battery electrodes which are suitable for simplified implementation, without requiring prior transformation stages.

It is thus an aim of the invention to overcome at least one of the disadvantages of the prior art, namely to provide a complete electrode formulation which is introduced directly into the metering devices of an extruder.

The invention is also targeted at providing a process for the manufacture of a Li-ion battery electrode which comprises a single extrusion stage starting from a complete electrode formulation, with a very low residence time.

The invention is also targeted at the electrodes prepared by means of this process. Finally, the invention is targeted at providing rechargeable Li-ion storage batteries comprising at least one such electrode.

### SUMMARY OF THE INVENTION

The invention relates first to a process for the continuous manufacture of a Li-ion battery electrode, said process comprising the following stages:
introducing all the constituents of the electrode in the solid state, and also a solvent, into an extruder metering device,
mixing by compounding in order to obtain a complete electrode formulation,
extruding said formulation for a period of time of less than 5 minutes, preferably of between 30 seconds and 3 minutes, in order to obtain an electrode material in the form of a paste with a Brookfield viscosity between 1500 and 20 000 cP,
applying said electrode material to a metal support in order to obtain a Li-ion battery electrode, and
drying said electrode material and calendering it.

Advantageously, said electrode formulation comprises from 65% to 95% of solid mixture and from 5% to 35% of solvent, and preferably from 70% to 90% of solid mixture for 10% to 30% of solvent.

Advantageously, said solid mixture comprises:
from 90% to 98% and preferably from 92% to 97% of an electrode active material,
from 0.5% to 3% and preferably from 1% to 2% of a fluoropolymer binder,
from 0.05% to 3% and preferably from 0.15% to 2% of carbon nanotubes,
from 0.25% to 3% and preferably from 1% to 3% of at least one carbon-based conductive filler distinct from the carbon nanotubes, and
from 0% to 1% and preferably from 0.25% to 1% of a dispersant, the sum of all these ingredients being 100%.

According to one embodiment, the solvent is water.

According to one embodiment, said solvent is an organic solvent chosen from: N-methylpyrrolidone (NMP), dimethyl sulfoxide (DMSO), dimethylformamide (DMF), ketones, acetates, furans, alkyl carbonates, alcohols and their mixtures. According to one embodiment, said electrode active material is in particular a metal oxide containing lithium.

According to one embodiment, said fluoropolymer binder is chosen in particular from homopolymers of polyvinylidene fluoride (PVDF) and copolymers or terpolymers based on vinylidene fluoride, polytetrafluoroethylene (PTFE) and their mixtures.

The carbon nanotubes can be of the single-wall, double-wall or multi-wall type, and are preferably multi-wall carbon nanotubes obtained following a chemical vapor deposition process.

According to one embodiment, said carbon-based conductive filler distinct from the carbon nanotubes is chosen from carbon nanofibers, carbon black and graphene.

According to one embodiment, the polymeric dispersant, which is distinct from said binder, is chosen from poly(vinylpyrrolidone), poly(phenylacetylene), poly(meta-phenylene vinylidene), polypyrrole, poly(para-phenylene benzobisoxazole), poly(vinyl alcohol) and their mixtures.

According to one embodiment, said metal support of the electrodes is generally made of aluminum for the cathode and of copper for the anode.

The process according to the invention makes it possible to obtain an electrode from a paste applied to said metal support.

The invention also relates to a Li-ion battery electrode obtained by the process described above.

According to one embodiment, said electrode is a cathode.

According to one embodiment, said electrode is an anode.

Another subject matter of the invention is a Li-ion storage battery comprising a negative electrode, a positive electrode and an electrolyte, in which at least one of the electrodes is obtained by the process described above.

Another subject matter of the invention is a complete electrode formulation comprising from 65% to 95% of solid mixture and from 5% to 35% of solvent, and preferably from 70% to 90% of solid mixture for 10% to 30% of solvent.

According to one embodiment, said solid mixture comprises:
from 90% to 98% and preferably from 92% to 97% of an electrode active material,
from 0.5% to 3% and preferably from 1% to 2% of a fluoropolymer binder,
from 0.05% to 3% and preferably from 0.15% to 2% of carbon nanotubes,
from 0.25% to 3% and preferably from 1% to 3% of at least one carbon-based conductive filler distinct from the carbon nanotubes, and
from 0% to 1% and preferably from 0.25% to 1% of a dispersant, the sum of all these ingredients being 100%.

The present invention makes it possible to overcome the disadvantages of the state of the art. More particularly, it provides a complete electrode formulation intended to be introduced directly into the metering devices of an extruder. The invention also provides a simplified process for the manufacture of a Li-ion battery electrode;
there is no prior transformation of the various starting materials used in the manufacture of an electrode;
the process comprises a single stage of extrusion starting from said complete electrode formulation, with a very low residence time, of less than 5 minutes. This has a major impact on the quality of the formulation and on the performance of the electrode, and also on the production cost, which decreases significantly. This is because one extrusion unit implementing the process according to the invention can replace up to 8 mixing units intended to supply 8 extrusion lines in the current processes for the manufacture of electrodes.

### BRIEF DESCRIPTION OF THE FIGURES

FIG. 1 is a graph illustrating a Ragone plot showing the variation in the discharge capacity of an electrode formulation, measured in mAh/g, as a function of the discharge rate (C-rate).

### DESCRIPTION OF THE EMBODIMENTS

The invention is now described in greater detail and in a nonlimiting way in the description which follows.

According to a first aspect, the invention relates to a process for the continuous manufacture of a Li-ion battery electrode, said process comprising the following stages:
introducing all the constituents of the electrode in the solid state, namely: from 90% to 98% of an electrode active material, from 0.5% to 3% of a fluoropolymer binder, from 0.05% to 3% of carbon nanotubes, from 0.25% to 3% of at least one carbon-based conductive filler distinct from the carbon nanotubes and from 0% to 1% of a dispersant, the sum of all the ingredients being 100%, and also a solvent, into an extruder metering device,
mixing by compounding in order to obtain an electrode formulation comprising from 65% to 95% of solid mixture and from 5% to 35% of solvent,
extruding said formulation for a period of time of less than 5 minutes, preferably of between 30 seconds and 3 minutes, in order to obtain an electrode material in the form of a paste with a Brookfield viscosity between 1500 and 20 000 cP,
applying said electrode material to a metal support in order to obtain a Li-ion battery electrode, and
calendering said electrode material.

Characteristically, this process employs a complete electrode formulation obtained by the compounding of a solid mixture, comprising all the ingredients of the electrode, and of a solvent.

Advantageously, said process comprises the following characteristics, if appropriate combined. The contents indicated are expressed by weight, unless otherwise indicated.

According to one embodiment, said electrode formulation comprises from 70% to 90% of solid mixture for 10% to 30% of solvent.

Advantageously, said solid mixture comprises:
from 92% to 97% of an electrode active material,
from 1% to 2% of a fluoropolymer binder,
from 0.15% to 2% of carbon nanotubes,
from 1% to 3% of at least one carbon-based conductive filler distinct from the carbon nanotubes, and
from 0.25% to 1% of a dispersant, the sum of all the ingredients being 100%.

### Solvent

The solvent used in the electrode formulation is water or an organic solvent.

According to one embodiment, the solvent is water.

According to one embodiment, said solvent is an organic solvent chosen from: N-methylpyrrolidone (NMP), dimethyl sulfoxide (DMSO), dimethylformamide (DMF), ketones, acetates, furans, alkyl carbonates, alcohols and their mixtures.

### Electrode Active Material

The electrode active material is chosen from the group consisting of:

i) transition metal oxides having a spinel structure of LiM₂O₄ type, where M represents a metal atom containing at least one of the metal atoms selected from the group formed by Mn, Fe, Co and Ni, said oxides preferably containing at least one Mn and/or Ni atom;
ii) transition metal oxides having a lamellar structure of LiMO₂ type, where M represents a metal atom containing at least one of the metal atoms selected from the group formed by Mn, Fe, Co and Ni;
iii) oxides having polyanionic frameworks of LiM_{y}(XO_{z})ₙ type, where:
M represents a metal atom containing at least one of the metal atoms selected from the group formed by Mn, Fe and Co, and
X represents one of the atoms selected from the group formed by P, Si, Ge, S and As.
   An example of oxides of this type is LiFePO₄.
   iv) vanadium-based oxides,
   v) graphite,
   vi) graphene,
   vii) carbon nanotubes,
   viii) silicon or its composites with carbon, and
   ix) titanates.

The electrode active materials i) to iii) are more suitable for the preparation of cathodes, while the electrode active materials iv) to ix) are more suitable for the preparation of anodes.

### Fluoropolymer Binder

The polymer binder is chosen from the group consisting of fluoropolymers defined in particular in the following way:

(i) those comprising at least 50 mol % of at least one monomer of formula (I):

CFX₁═CX₂X₃ (I)

where X₁, X₂ and X₃ independently denote a hydrogen or halogen atom (in particular a fluorine or chlorine atom), such as poly(vinylidene fluoride) (PVDF), preferably in a form, poly(trifluoroethylene) (PVF3), polytetrafluoroethylene (PTFE), copolymers of vinylidene fluoride with either hexafluoropropylene (HFP) or trifluoroethylene (VF3) or tetrafluoroethylene (TFE) or chlorotrifluoroethylene (CTFE), fluoroethylene/propylene (FEP) copolymers, copolymers of ethylene with either fluoroethylene/propylene (FEP) or tetrafluoroethylene (TFE) or chlorotrifluoroethylene (CTFE);
(ii) those comprising at least 50 mol % of at least one monomer of formula (II):

RO—CH═CH₂ (II)

where R denotes a perhalogenated (in particular perfluorinated) alkyl radical, such as perfluoropropyl vinyl ether (PPVE), perfluoroethyl vinyl ether (PEVE) and copolymers of ethylene with perfluoromethyl vinyl ether (PMVE), said binder preferably being PVDF.

The term “PVDF” employed here comprises vinylidene fluoride (VDF) homopolymers or copolymers of VDF and of at least one other comonomer in which the VDF represents at least 50 mol %. The comonomers which can be polymerized with VDF are chosen from vinyl fluoride, trifluoroethylene, chlorotrifluoroethylene (CTFE), 1,2-difluoroethylene, tetrafluoroethylene (TFE), hexafluoropropylene (HFP), perfluoro(alkyl vinyl) ethers, such as perfluoro(methyl vinyl) ether (PMVE), perfluoro(ethyl vinyl) ether (PEVE) or perfluoro(propyl vinyl) ether (PPVE), perfluoro(1,3-dioxole), perfluoro(2,2-dimethyl-1,3-dioxole) (PDD), the product of formula CF₂═CFOCF₂CF(CF₃)OCF₂CF₂X in which X is SO₂F, CO₂H, CH₂OH, CH₂OCN or CH₂OPO₃H, the product of formula CF₂═CFOCF₂CF₂SO₂F, the product of formula F(CF₂)ₙCH₂OCF═CF₂ in which n is 1, 2, 3,4 or 5, the product of formula R1CH₂OCF═CF₂ in which R1 is hydrogen or F(CF₂)_{z} and z has the value 1, 2, 3 or 4, the product of formula R3OCF═CH₂ in which R3 is F(CF₂)_{z} and z has the value 1, 2, 3 or 4, or also perfluorobutylethylene (PFBE), fluorinated ethylene propylene (FEP), 3,3,3-trifluoropropene, 2-trifluoromethyl-3,3,3-trifluoro-1-propene, 2,3,3,3-tetrafluoropropene or HFO-1234yf, E-1,3,3,3-tetrafluoropropene or HFO-1234zeE, Z-1,3,3,3-tetrafluoropropene or HFO-1234zeZ, 1,1,2,3-tetrafluoropropene or HFO-1234yc, 1,2,3,3-tetrafluoropropene or HFO-1234ye, 1,1,3,3-tetrafluoropropene or HFO-1234zc, and chlorotetrafluoropropene or HCFO-1224.

According to one embodiment, the copolymer is a terpolymer.

According to another embodiment, said binder is a fluoropolymer carrying functional group(s) capable of developing adhesion to a metal substrate and good cohesion of the material making up the electrode. It can be a polymer based on VDF (containing at least 50 mol % of VDF) additionally comprising units carrying at least one of the following functional groups: carboxylic acid, carboxylic acid anhydride, carboxylic acid esters, epoxy groups (such as glycidyl), amide groups, alcohol groups, carbonyl groups, mercapto groups, sulfide, oxazoline groups and phenol groups. The functional group is introduced onto the fluoropolymer by a chemical reaction which can be grafting or a copolymerization of the fluoropolymer with a compound carrying at least one of said functional groups, according to techniques well known to a person skilled in the art.

According to one embodiment, the carboxylic acid functional group is a hydrophilic group of (meth)acrylic acid type chosen from acrylic acid, methacrylic acid, hydroxyethyl (meth)acrylate, hydroxypropyl (meth)acrylate and hydroxyethylhexyl (meth)acrylate.

According to one embodiment, the units carrying the carboxylic acid functional group additionally comprise a heteroatom chosen from oxygen, sulfur, nitrogen and phosphorus.

When the fluoropolymer is functionalized, the content of functional groups ensuring the adhesion of the binder to a metal is at least 0.05 mol % and preferably at least 0.15 mol %.

### Carbon Nanotubes (CNTs)

The carbon nanotubes employed in the formulation according to the invention can be of the single-wall, double-wall or multi-wall type. Double-wall nanotubes can in particular be prepared as described by Flahaut et al. in Chem. Comm. (2003), 1442. Multi-wall nanotubes can for their part be prepared as described in the document WO 03/02456. Preference is given according to the invention to multi-wall carbon nanotubes obtained according to a chemical vapor deposition (or CVD) process, by catalytic decomposition of a carbon source (preferably of plant origin), as described in particular in the application EP 1 980 530 of the applicant company.

The nanotubes usually have a mean diameter ranging from 0.1 to 100 nm, preferably from 0.4 to 50 nm and better still from 1 to 30 nm, indeed even from 10 to 15 nm, and advantageously a length of 0.1 to 10 μm. Their length/diameter ratio is preferably greater than 10 and most often greater than 100. Their specific surface is, for example, between 100 and 300 m²/g, advantageously between 200 and 300 m²/g, and their bulk density can in particular be between 0.05 and 0.5 g/cm³ and more preferentially between 0.1 and 0.2 g/cm³. The multi-wall nanotubes can, for example, comprise from 5 to 15 sheets (or walls) and more preferentially from 7 to 10 sheets. These nanotubes may or may not be treated.

An example of raw carbon nanotubes is in particular available commercially from Arkema under the trade name Graphistrength® C100.

These nanotubes can be purified and/or treated (for example oxidized) and/or functionalized, before they are employed in the process according to the invention.

The nanotubes can be purified by washing using a sulfuric acid solution, so as to free them from possible residual inorganic and metallic impurities, such as, for example, iron, originating from their preparation process. The ratio by weight of the nanotubes to the sulfuric acid can in particular be between 1:2 and 1:3. The purification operation can moreover be carried out at a temperature ranging from 90° C. to 120° C., for example for a period of time of 5 to 10 hours. This operation can advantageously be followed by stages in which the purified nanotubes are rinsed with water and dried. As a variant, the nanotubes can be purified by high-temperature heat treatment, typically of greater than 1000° C.

The oxidation of the nanotubes is advantageously carried out by bringing them into contact with a sodium hypochlorite solution containing from 0.5% to 15% by weight of NaOCl and preferably from 1% to 10% by weight of NaOCl, for example in a ratio by weight of the nanotubes to the sodium hypochlorite ranging from 1:0.1 to 1:1. The oxidation is advantageously carried out at a temperature of less than 60° C. and preferably at ambient temperature, for a period of time ranging from a few minutes to 24 hours. This oxidation operation can advantageously be followed by stages in which the oxidized nanotubes are filtered and/or centrifuged, washed and dried.

The functionalization of the nanotubes can be carried out by grafting reactive units, such as vinyl monomers, to the surface of the nanotubes. The constituent material of the nanotubes is used as radical polymerization initiator after having been subjected to a heat treatment at more than 900° C., in an anhydrous medium devoid of oxygen, which is intended to remove the oxygen-comprising groups from its surface. It is thus possible to polymerize methyl methacrylate or hydroxyethyl methacrylate at the surface of carbon nanotubes for the purpose of facilitating in particular their dispersion in the fluorinated binder.

It is possible to use, in the present invention, crude nanotubes, that is to say nanotubes which are neither oxidized nor purified nor functionalized and have not been subjected to any other chemical and/or heat treatment. As a variant, it is possible to use purified nanotubes, in particular purified by high-temperature heat treatment.

Preferably, carbon nanotubes are employed in the present invention in the form of solid aggregates with a size of between 1 μm and 5 mm, preferably between 200 μm and 3 mm.

Carbon-Based Conductive Filler Other than the Carbon Nanotubes

These fillers comprise at least one filler chosen from carbon nanofibers, graphenes and carbon black.

Carbon black is used in powder form or in compacted form.

Carbon nanofibers are, like carbon nanotubes, nanofilaments produced by chemical vapor deposition (or CVD) starting from a carbon-based source which is decomposed over a catalyst comprising a transition metal (Fe, Ni, Co, Cu), in the presence of hydrogen, at temperatures of 500 to 1200° C. However, these two carbon-based fillers differ in their structure (I. Martin-Gullon et al., Carbon, 44 (2006), 1572-1580). This is because carbon nanotubes consist of one or more graphene sheets wound concentrically around the axis of the fiber to form a cylinder having a diameter of 10 to 100 nm. In contrast, carbon nanofibers are composed of relatively organized graphitic regions (or turbostratic stacks), the planes of which are inclined at variable angles with respect to the axis of the fiber. These stacks can take the form of platelets, fish bones or dishes stacked in order to form structures having a diameter generally ranging from 100 nm to 500 nm, indeed even more. Furthermore, carbon black is a colloidal carbon-based material manufactured industrially by incomplete combustion of heavy petroleum products, which exists in the form of carbon spheres and of aggregates of these spheres, the dimensions of which are generally between 10 and 1000 nm.

Use is preferably made of carbon nanofibers having a diameter of 100 to 200 nm, for example of approximately 150 nm (such as those sold under the reference VGCFe from Showa Denko), and advantageously a length of 100 to 200 μm.

The term “graphene” denotes a flat, isolated and separate sheet of graphite but also, by extension, an assembly comprising between one and several tens of sheets and exhibiting a flat or relatively undulating structure. This definition thus encompasses FLGs (Few Layer Graphene), NGPs (Nanosized Graphene Plates), CNSs (Carbon NanoSheets) and GNRs (Graphene NanoRibbons). On the other hand, it excludes carbon nanotubes and nanofibers, which consist, respectively, of the winding of one or more graphene sheets coaxially and of the turbostratic stacking of these sheets.

Furthermore, it is preferable for the graphene used according to the invention not to be subjected to an additional stage of chemical oxidation or of functionalization.

The graphene used according to the invention is advantageously obtained by chemical vapor deposition or CVD, preferably according to a process using a pulverulent catalyst based on a mixed oxide. It is characteristically provided in the form of particles with a thickness of less than 50 nm, preferably of less than 15 nm and more preferentially of less than 5 nm, and with lateral dimensions of less than a micron, preferably from 10 nm to less than 1000 nm, more preferentially from 50 to 600 nm, indeed even from 100 to 400 nm. Each of these particles generally includes from 1 to 50 sheets, preferably from 1 to 20 sheets and more preferentially from 1 to 10 sheets, indeed even from 1 to 5 sheets, which are capable of being separated from one another in the form of independent sheets, for example during an ultrasound treatment.

### Dispersant

The polymeric dispersant is distinct from said fluorinated binder. It is advantageously chosen from poly(vinylpyrrolidone), poly(phenylacetylene), poly(meta-phenylene vinylidene), polypyrrole, poly(para-phenylene benzobisoxazole), poly(vinyl alcohol) and their mixtures.

### Unfolding of the Process

According to one embodiment, the process for the manufacture of an electrode according to the invention uses, as compounding device, a microextruder sold by DSM at the laboratory level. Industrially, Buss co-kneaders or twin-screw extruders are used.

The microextruder comprises: feeding means, in particular at least one hopper for pulverulent materials and/or at least one injection pump for liquid materials; high-shear kneading means, for example a corotating or counterrotating twin-screw extruder; an outlet head which gives its shape to the exiting material; and means for cooling the material, under air or using a water circuit.

In the first stage of the process according to the invention, the solvent and the components of the solid mixture, namely: the electrode active material, the fluoropolymer binder, the carbon nanotubes, the other carbon-based conductive fillers and the polymeric dispersant, which were premixed beforehand, are introduced into the extruder. The solid mixture is introduced gradually, while monitoring the rise in the torque.

During the extrusion stage, the temperature in the extruder is maintained between 50 and 200° C., according to the configuration of the extruder.

According to one embodiment, the CNTs and/or the carbon-based conductive filler distinct from the carbon nanotubes are mixed with solvent, in the premetering device of the extrusion line. This is because CNTs have the ability to adsorb liquids without losing the solid form. For example, 100 g of Graphistrength® C100 CNTs can absorb 800 g of the solvent NMP without losing the fluidity of the powder. Similarly, carbon black exhibits a high solvent adsorption capacity. The mixings of CNTs and/or of other conductive fillers with the solvent, carried out in the premetering device of the extrusion line, can be achieved with the gravimetric metering device directly in the main hopper of the extruder at the same time as the other constituents of the solid mixture. This avoids the injection of liquid into the compounding zone and considerably improves the mixing quality.

This predispersion stage is particularly suitable for high grammages of electrodes (greater than or equal to 25 mg/cm²).

According to one embodiment, which can be combined with that described above, all or part of the solvent present in the electrode formulation originates from a latex comprising the particles of fluoropolymer binder and said solvent.

Mixing by compounding the solvent and the solid mixture is subsequently carried out in order to obtain a complete electrode formulation.

The extrusion of said formulation is carried out in a single stage, the duration of which is less than 5 minutes, preferably of between 30 seconds and 3 minutes, in order to obtain an electrode material in the form of a paste with a Brookfield viscosity between 1500 and 20 000 cP.

These extrusion conditions are very favorable for codispersing the active filler and the CNTs.

The extrusion line can be equipped with a vacuum pump after the compounding zone in order to discharge a part of the solvent. The purpose of this is to recover the electrode material in the form of a powder which can be used for the deposition of coating by the dry route (dry process) or by the powder route, followed by calendering. Said material suitable for the dry route (dry process) can contain small amounts of organic solvent or water because this does not change the physical state of the formulation; the material remains able to be handled in the solid state.

According to one embodiment, the electrode material obtained after extrusion can be stored and conditioned for up to 7 days with stirring in the liquid state, or up to 6 months in the solid state, before being employed in the manufacture of the electrode.

The electrode material thus obtained is applied to a metal collector in order to obtain a Li-ion battery electrode, for example by means of a device with a doctor blade for coating. The metal supports of the electrodes are generally made of aluminum for the cathode and of copper for the anode.

The electrode material is subsequently dried, and is subsequently subjected to calendering. According to one embodiment, the calendering is carried out in several stages, at least one stage of which is carried out under hot conditions (between 70 and 160° C. depending on the amount of residual solvent), during which the powder is transformed into a film having a thickness of 50 to 150 μm and a porosity of 10 to 40 mg/cm².

Another subject matter of the invention is the electrode obtained by the method described above. According to one embodiment, said electrode is a cathode. According to one embodiment, said electrode is an anode.

Another subject matter of the invention is a Li-ion storage battery comprising a negative electrode, a positive electrode and an electrolyte, in which at least one of the electrodes is obtained by the process described above. The quality of the complete electrode formulation and its rapid transformation by virtue of the process according to the invention have a beneficial impact on the performance of the electrode.

Another subject matter of the invention is the complete electrode formulation described above, comprising from 65% to 95% of solid mixture and from 5% to 35% of solvent, and preferably from 70% to 90% of solid mixture for 10% to 30% of solvent. This formulation is particularly suitable for being employed in the dry process according to the invention.

### EXAMPLES

The following examples nonlimitingly illustrate the scope of the invention.

### Example 1 According to the Invention

A complete cathode formulation is prepared, the solid mixture of which, having the following composition by weight, is prepared by dry premixing beforehand:
93.9% of powder of NMC 622 (LiNi_{0.6}Mn_{0.2}Co_{0.2}O₂) sold by Umicore
1.5% of PVDF homopolymer Kynar® HSV 900
2% of purified CNTs Graphistrength® C100
2% of carbon black LI100 sold by Denka
0.6% of PVP.

A microextruder sold by DSM is used. NMP is introduced and then said solid mixture. The amount of NMP added to said solid mixture is adjusted so as to obtain viscosities of between 6000 and 8000 cP.

The following stages are followed:
introduction of 9.35 ml of NMP Into the extruder, preheated to 50° C.; once the NMP is introduced, the screw speed is increased to 240 rpm;
42.6 g of the abovementioned solid mixture are gradually introduced over 30-60 seconds; the torque is continually monitored; it is adjusted with NMP so as to remain in the range 1000-1400 N·m;
once the torque has stabilized, 4.9 g of NMP are gradually introduced over 30-60 seconds; the torque gradually drops to 100 N·m;
the product (cathode material) is recovered in the form of a paste, the NMP content and fineness (North gauge of 0 to 100 μm) of which are tested; the solids content is 78%;
the paste thus obtained is used to coat an aluminum sheet by means of a device with a doctor blade for coating; the electrode is subsequently dried in a ventilated oven at 130° C. for 30 minutes;
the thickness of the coating is adjusted according to the surface charge desired, at 18 mg/cm²;
calendering at 70° C. is subsequently carried out and the density of the electrode is checked so as to obtain a porosity of 40%;
the calendered electrodes are subsequently used to evaluate the adhesion between the paste and the metal support, by means of a 180° peel test.

The cathodes thus prepared are used to prepare a button cell with a Li anode, a Celgard PP2500 separator and an electrolyte formulation (1M LiFSI in EC/DEC (3/7 V/V)+2% FEC).

The battery thus obtained is tested according to the Ragone protocol shown in Table 1:

TABLE 1

| Cathode | Charge | Discharge |
|---|---|---|
| Cycle no 1 | C/12 | C/12 |
| Cycle no 2 | C/8 | C/8 |
| Cycle no 1 | C/4 | C/4 |
| Cycle no 3 | C/4 | C/2 |
| Cycle no 4 | C/4 | C |
| Cycle no 5 | C/4 | 2 C |
| Cycle no 6 | C/4 | 4 C |
| Cycle no 7 | C/4 | 8 C |
| Cycle no 8 | C/4 | 10 C |
| Cycle no 9 | C/4 | 15 C |
| Cycle no 10 | C/4 | 20 C |
| Cycle no 11 | C/4 | 30 C |
| Cycle no 12 | C/4 | 35 C |
| Cycle no 13 | C/4 | 40 C |

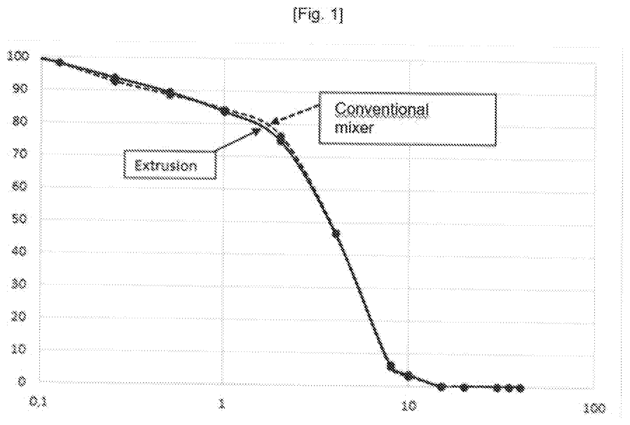

The results obtained for a battery according to the invention and also those obtained with a battery, the cathode of which is prepared by means of a conventional mixer (see comparative example 2 below), are represented in the diagram of FIG. 1, which shows the variation in the discharge capacity of an electrode formulation, measured in mAh/g, as a function of the discharge rate (C-rate).

These results show that the behavior of a battery comprising a cathode prepared by the process according to the invention is similar to that of a battery comprising a cathode prepared by the conventional methods.

### Example 2 (Comparative)

The same electrode formulation as in example 1 was prepared using a conventional mixer.

### Preparation of a CNT/PVDF/NMP Masterbatch

A 5% by weight solution of PVDF (Kynar® HSV 900 from Arkema) was produced beforehand by dissolution of the powder of the polymer in N-methylpyrrolidone (NMP); the solution was stirred at 50° C. for 60 min.

The CNTs (Graphistrength® C100 from Arkema) were introduced into the first feed hopper of a Buss® MDK 46 (L/D=11) co-kneader, equipped with a recovery extrusion screw and with a granulation device. The 5% solution of PVDF (Kynar® HSV 900) in N-methylpyrrolidone (NMP) was injected in the liquid form at 80° C. into the 1st zone of the co-kneader. The set temperature values and the throughput within the co-kneader were as follows: Zone 1: 80° C., Zone 2: 80° C., Screw: 60° C., Throughput 15 kg/h. On exiting from the die, the granules of the masterbatch were cut under dry conditions. The granules were packaged in an airtight container to prevent loss of NMP during storage. The composition of the final masterbatch was as follows: 30% by weight of carbon nanotubes, 3.5% by weight of PVDF resin and 66.5% by weight of NMP.

Use of the CNT/PVDF/NMP masterbatch for the manufacture of an electrode Stage a) 20 g of masterbatch granules were wetted with 160 g of NMP solvent. After 2 h of static impregnation at ambient temperature, the granules of the masterbatch were dispersed in the solvent using a mixer of Silverson® L4RT type at 6000 rpm for 15 minutes. Significant heating during the dispersion operation was observed: the mixture containing the CNTs reached a temperature of 67° C. The suspension obtained was denoted by “CNT Premix”.

Stage b) 14.3 g of Kynar® HSV 900 and 5.72 g of PVP were dissolved in 276 g of NMP solvent using a stirrer of disk mixer type for 4 hours.

Stage c) 279 g of powder of NMC 622 (LiNi_{0.6}Mn_{0.2}Co_{0.2}O₂) sold by Umicore were dispersed in the Kynar solution; during this stage, the powder was gradually added with stirring (600 rpm). The suspension obtained was denoted by “NMC Premix”.

Stage d) In order to obtain a good dispersion of the CNTs around the NMC active material, the CNT Premix and the NMC Premix obtained respectively during stages a) and c) were mixed for 10 minutes using a flocculation stirrer at 600 rpm, then using a Silverson® L4RT mixer for 15 minutes at 3000 rpm. The composition of the ink as dry matter was as follows: 2% of CNT, 5% of Kynar® HSV 900 and 93% of NMC 622 with a solids content of 40% in the NMP solvent.

Stage e) The pasty formulation thus obtained is used to coat an aluminum sheet by means of a device with a doctor blade for coating; the electrode is subsequently dried in a ventilated oven at 130° C. for 30 minutes.

Stage f) Calendering at 70° C. is subsequently carried out and the density of the electrode is checked so as to obtain a porosity of 40%.

### Example 3—Preparation of a Cathode Formulation According to the Invention the Cathode Formulation Contains

93.9% of powder of NMC 622 (LiNi_{0.6}Mn_{0.2}Co_{0.2}O₂) sold by Umicore
1.5% of PVDF homopolymer Kynar® HSV 900
2% of purified CNTs Graphistrength® C100
2% of carbon black (CB) L1100 sold by Denka
0.6% of PVP.

Stage a) 200 g of Graphistrength® C100 HP CNTs and 200 g of carbon black are premixed with 1000 g of NMP in a 5 liter drum placed on rotating rolls for 15 min. The NMP solvent is adsorbed by the CNTs and CBs without changing the appearance of the powder.

Stage b) The mixture from stage a) was introduced into a 10 liter drum containing 9390 g of NMC 622, 150 g of PVDF and 60 g of PVP. The drum was placed on the rotating rolls for 15 min.

Stage c) Extrusion. The mixture from stage b) was introduced into the gravimetric metering device, including the main metering device, of the BC21 extruder from Clextral. The extruder is equipped with a feed hopper. The screw profile has two mixing zones and one atmospheric venting well upstream of the 2nd mixing zone. The mixture was fed with the flow rate of 10 kg/h into the feed hopper. The screw speed is 300 rpm. The material was recovered directly at the outlet of the screws (without a die) in the form of a homogeneous powder with the “wet” appearance in a drum. The set temperature of all the zones of the extruder is 60° C. The % by weight of NMP in the extruded formulation is 8.5%.

Stage d) The extruded formulation was applied to a 25 μm aluminum (Al) sheet, using a device with a doctor blade for coating, the support-scraper space being 400 μm.

Subsequently, the Al support with the powder coating was placed in a ventilated oven at 160° C. for 3 min in order to consolidate the particles before the calendering.

Stage e) Calendering. The Al-supported coating is subsequently calendered at 160° C. in 3 stages, while reducing the inter-roll gap of the calenders: 1st passage at 300 μm, 2nd at 250 μm and 3rd at 150 μm. Subsequently, the coating was dried at 130° C. for 30 min in order to discharge the residual NMP. The gap for the definitive calendering was adjusted in order to observe the final porosity of 40% as in examples 1 and 2.

1. A process for the continuous manufacture of a Li-ion battery electrode, said process comprising the following stages:
introducing the constituents of the electrode in the solid state, said constitutents comprising from 90% to 98% of an electrode active material, from 0.5% to 3% of a fluoropolymer binder, from 0.05% to 3% of carbon nanotubes, from 0.25% to 3% of at least one carbon-based conductive filler distinct from the carbon nanotubes and from 0% to 1% of a dispersant, the sum of constituents being 100%, and also a solvent, into an extruder metering device,
mixing by compounding to obtain an electrode formulation comprising from 65% to 95% of solid mixture and from 5% to 35% of solvent,
extruding said electrode formulation for a period of time of less than 5 minutes, to obtain an electrode material in the form of a paste with a Brookfield viscosity between 1500 and 20 000 cP,
applying said electrode material to a metal support to obtain a Li-ion battery electrode, and
calendering said electrode material.

2. The process of claim 1, in which the electrode formulation comprises from 70% to 90% of solid mixture for 10% to 30% of solvent.

3. The process of claim 1, in which said constituents comprises:
from 92% to 97% of an electrode active material,
from 1% to 2% of a fluoropolymer binder,
from 0.15% to 2% of carbon nanotubes,
from 1% to 3% of at least one carbon-based conductive filler distinct from the carbon nanotubes, and
from 0.25% to 1% of a dispersant,
the sum of all the constituents being 100%.

4. The process of claim 1, in which the solvent is water or an organic solvent selected from the group consisting of: N-methylpyrrolidone, dimethyl sulfoxide, dimethylformamide, ketones, acetates, furans, alkyl carbonates, alcohols and their mixtures.

5. The process of claim 1, in which said electrode active material is chosen from the group consisting of:
i) transition metal oxides having a spinel structure of LiM₂O₄ type, where M represents a metal atom containing at least one of the metal atoms selected from the group formed by Mn, Fe, Co and Ni;
ii) transition metal oxides having a lamellar structure of LiMO₂ type, where M represents a metal atom containing at least one of the metal atoms selected from the group consisting of Mn, Fe, Co and Ni;
iii) oxides with polyanionic frameworks of LiM_{y}(XO_{z}))ₙ type where M represents a metal atom containing at least one of the metal atoms selected from the group consisting of Mn, Fe and Co, and X represents one of the atoms selected from the group consisting of P, Si, Ge, S and As;
iv) vanadium-based oxides;
v) graphite;
vi) graphene;
vii) carbon nanotubes;
viii) silicon or its composites with carbon; and
ix) titanates.

6. The process of claim 1, in which the fluoropolymer binder is chosen from the group consisting of fluoropolymers defined in the following way:
(i) those comprising at least 50 mol % of at least one monomer of formula (I):
CFX₁═CX₂X₃ (I)
where X₁, X₂ and X₃ independently denote a hydrogen or halogen atom and
(ii) those comprising at least 50 mol % of at least one monomer of formula (II): R—O—CH═CH₂ (II)
where R denotes a perhalogenated.

7. The process of claim 1, in which said binder is a polyvinylidene fluoride chosen from vinylidene fluoride (VDF) homopolymers and copolymers of VDF and of at least one other comonomer in which the VDF represents at least 50 mol %, the comonomers which can be polymerized with VDF being chosen from: vinyl fluoride, trifluoroethylene, chlorotrifluoroethylene (CTFE), 1,2-difluoroethylene, tetrafluoroethylene (TFE), hexafluoropropylene (HFP), perfluoro(alkyl vinyl) ethers, perfluoro(1,3-dioxole), perfluoro(2,2-dimethyl-1,3-dioxole) (PDD), the product of formula CF₂═CFOCF₂CF(CF₃)OCF₂CF₂X in which X is SO₂F, CO₂H, CH₂OH, CH₂OCN or CH₂OPO₃H, the product of formula CF₂═CFOCF₂CF₂SO₂F, the product of formula F(CF₂), CH₂OCF═CF₂ in which n is 1, 2, 3, 4 or 5, the product of formula R1CH₂OCF═CF₂ in which R1 is hydrogen or F(CF₂)_{z} and z has the value 1, 2, 3 or 4, the product of formula R3OCF═CH₂ in which R3 is F(CF₂)_{z} and z has the value 1, 2, 3 or 4, or also perfluorobutylethylene (PFBE), fluorinated ethylene propylene (FEP), 3,3,3-trifluoropropene, 2-trifluoromethyl-3,3,3-trifluoro-1-propene, 2,3,3,3-tetrafluoropropene or HFO-1234yf, E-1,3,3,3-tetrafluoropropene or HFO-1234zeE, Z-1,3,3,3-tetrafluoropropene or HFO-1234zeZ, 1,1,2,3-tetrafluoropropene or HFO-1234yc, 1,2,3,3-tetrafluoropropene or HFO-1234ye, 1,1,3,3-tetrafluoropropene or HFO-1234zc, and chlorotetrafluoropropene or HCFO-1224.

8. The process of claim 1, in which the carbon nanotubes are in the form of solid aggregates with a size between 1 μm and 5 mm, and are chosen from nanotubes of the single-wall, double-wall or multi-wall type.

9. The process of claim 1, in which the carbon-based conductive filler other than the carbon nanotubes comprises at least one filler chosen from carbon nanofibers, graphenes and carbon black.

10. The process of claim 1, in which said polymeric dispersant is chosen from poly(vinylpyrrolidone), poly(phenylacetylene), poly(meta-phenylene vinylidene), polypyrrole, poly(para-phenylene benzobisoxazole), poly(vinyl alcohol) and their mixtures.

11. A Li-ion storage battery comprising an anode, a cathode and an electrolyte, in which the cathode is obtained by the process of claim 1.

12. A Li-ion storage battery comprising an anode, a cathode and an electrolyte, in which the anode is obtained by the process of claim 1.

13. A Li-ion storage battery comprising an anode, a cathode and an electrolyte, in which the anode and the cathode are obtained by the process of claim 1.

14. A Li-ion battery complete electrode formulation comprising from 65% to 95% of solid mixture and from 5% to 35% of solvent, wherein said solid mixture comprises:
from 92% to 97% of an electrode active material,
from 1% to 2% of a fluoropolymer binder,
from 0.15% to 2% of carbon nanotubes,
from 1% to 3% of at least one carbon-based conductive filler distinct from the carbon nanotubes, and
from 0.25% to 1% of a dispersant,
the sum of the ingredients in the solid mixture being 100%,
wherein the solvent is water or an organic solvent chosen from: N-methylpyrrolidone, dimethyl sulfoxide, dimethylformamide, ketones, acetates, furans, alkyl carbonates, alcohols and their mixtures;
wherein said electrode active material is chosen from the group consisting of:
i) transition metal oxides having a spinel structure of LiM₂O₄ type, where M represents a metal atom containing at least one of the metal atoms selected from the group consisting of Mn, Fe, Co and Ni:
ii) transition metal oxides having a lamellar structure of LiMO₂ type, where M represents a metal atom containing at least one of the metal atoms selected from the group consisting of Mn, Fe, Co and Ni:
iii) oxides with polyanionic frameworks of LiMₓ(XO_{z})ₙ type where M represents a metal atom containing at least one of the metal atoms selected from the group consisting of Mn, Fe and Co, and X represents one of the atoms selected from the group consisting of P, Si, Ge, S and As:
iv) vanadium-based oxides:
v) graphite:
vi) graphene:
vii) carbon nanotubes:
viii) silicon or its composites with carbon; and
ix) titanates.
